(19) United States
(12) Patent Application Publication
(10) Pub. No.: US 2023/0124375 A1
(43) Pub. Date: Apr. 20, 2023

(54) DISPLAY SYSTEM AND DISPLAY METHOD

(71) Applicant: TOYOTA JIDOSHA KABUSHIKI KAISHA, Toyota-shi Aichi-ken (JP)

(72) Inventors: Kosuke Akatsuka, Mishima-shi Shizuoka-ken (JP); Rio Suda, Toyota-shi Aichi-ken (JP); Hirofumi Momose, Numazu-shi Shizuoka-ken (JP); Takashi Suzuki, Susono-shi Shizuoka-ken (JP)

(73) Assignee: TOYOTA JIDOSHA KABUSHIKI KAISHA, Toyota-shi Aichi-ken (JP)

(21) Appl. No.: 17/967,465

(22) Filed: Oct. 17, 2022

(30) Foreign Application Priority Data
Oct. 20, 2021 (JP) 2021-171604

(51) Int. Cl. B60W 50/14; B60W 40/103; B60W 40/105; B60W 50/00; B60K 35/00; G06V 20/56

(52) U.S. Cl. CPC B60W 50/14; B60W 40/103; B60W 40/105; B60W 50/0097; B60K 35/00; G06V 20/56; B60W 2050/146; B60W 2420/42; B60W 2520/20; B60K 2370/176; B60K 2370/1868

(57) ABSTRACT

A display system comprises a camera for capturing traveling video of a vehicle. a sensor for detecting traveling state information of the vehicle, a display device, and one or more processors. The one or more processors execute calculating a steady circular turning trajectory of the vehicle based on the traveling state information, estimating a slip angle of the vehicle based on the traveling state information, rotating the steady circular turning trajectory in accordance with the slip angle to calculate a predicted trajectory, and displaying the traveling video and the predicted trajectory on the display device in a superimposed manner.

### CROSS-REFERENCE TO RELATED APPLICATION

The present application claims priority under 35 U.S.C. § 119 to Japanese Patent Application No. 2021-171604, filed Oct. 20, 2021, the contents of which application are incorporated herein by reference in their entirety.

### BACKGROUND

### Technical Field

The present disclosure relates to a technique for displaying traveling video of a vehicle on a display device.

### Background Art

Conventionally, a technique for supporting smooth driving operation by displaying an image captured by a camera included in a vehicle on a display device and displaying an auxiliary display in a superimposed manner has been considered. For example, Patent Literature 1 discloses a parking assist device that captures an image of the rear of a vehicle with a camera during a parking operation, displays the image from the camera as a rear image on a display provided in the vehicle, and displays a predicted travel trajectory that changes depending on a state of a steering angle superimposed on the rear image. The parking assist device displays a warning area that is a measure of a distance behind the vehicle superimposed on the display.

### List of Related Art

Patent Literature 1: Japanese Laid-Open Patent Application Publication No. JP-2004-262449

### SUMMARY

The inventors of the present disclosure consider a display system which displays traveling video and a predicted trajectory of a vehicle on a display device in a superimposed manner. Such a display system is particularly effective in remote driving in which it is difficult to obtain a feeling of driving.

When a steering angle is given to the vehicle and the vehicle turns, it is conceivable to give a steady circular turning trajectory as the predicted trajectory. However, when the steady circular turning trajectory is simply superimposed on the traveling video as the predicted trajectory, there is a possibility that the predicted trajectory is displayed with deflection to the outside or inside of the turning with respect to the actual trajectory.

An object of the present disclosure is to provide a display system and a display method capable of displaying the traveling video and the predicted trajectory of the vehicle in a superimposed manner with high accuracy.

A first disclosure is directed to a display system.

The display system comprises:

a camera for capturing traveling video of a vehicle;

a sensor for detecting traveling state information of the vehicle;

a display device; and

one or more processors configured to execute:
calculating a steady circular turning trajectory of the vehicle based on the traveling state information;
estimating a slip angle of the vehicle based on the traveling state information;
rotating the steady circular turning trajectory in accordance with the slip angle to calculate a predicted trajectory; and
displaying the traveling video and the predicted trajectory on the display device in a superimposed manner.

A second disclosure is directed to a display system further having the following features with respect to the display system according to the first disclosure.

The one or more processors are further configured to execute:
calculating a stopping position of the vehicle based on the traveling state information;
rotating the stopping position in accordance with the slip angle to calculate a predicted stopping position; and
displaying the predicted stopping position to be superimposed on the traveling video on the display device.

A third disclosure is directed to a display system further having the following features with respect to the display system according to the second disclosure.

The calculating the stopping position includes:
calculating a reaction distance determined by a vehicle speed of the vehicle;
calculating a braking distance determined by the vehicle speed and a predetermined deceleration; and
calculating, as the stopping position, a position advanced from a current position of the vehicle along the steady circular turning trajectory by the reaction distance and the braking distance.

A fourth disclosure is directed to a display method.

The display method comprises:

calculating a steady circular turning trajectory of the vehicle based on traveling state information of the vehicle;

estimating a slip angle of the vehicle based on the traveling state information;

rotating the steady circular turning trajectory in accordance with the slip angle to calculate a predicted trajectory; and

displaying the traveling video and the predicted trajectory on the display device in a superimposed manner.

A fifth disclosure is directed to a display method further having the following features with respect to the display method according to the fourth disclosure.

The display method further comprises:
calculating a stopping position of the vehicle based on the traveling state information;
rotating the stopping position in accordance with the slip angle to calculate a predicted stopping position; and
displaying the predicted stopping position to be superimposed on the traveling video on the display device.

According to the present disclosure, a steady circular turning trajectory is calculated and a slip angle of the vehicle is estimated. And a predicted trajectory is calculated by rotating the steady circular turning trajectory in accordance with the slip angle. Then, the predicted trajectory and the traveling video are displayed in a superimposed manner. It is thus possible to suppress the deviation of the predicted trajectory with respect to the actual trajectory, and display the traveling video and the predicted trajectory of the vehicle in a superimposed manner with high accuracy.

### BRIEF DESCRIPTION OF DRAWINGS

FIG. 1 is a block diagram for explaining an AR display function by a display system according to the present embodiment;

FIG. 2 is a conceptual diagram showing an example of a predicted trajectory and a predicted stopping position of the vehicle calculated by the vehicle motion calculation processing shown in FIG. 1;

FIG. 3 is a conceptual diagram showing an example of a predicted trajectory and a predicted stopping position calculated in the coordinate conversion processing shown in FIG. 1;

FIG. 4 is a conceptual diagram for explaining a problem in AR display of a predicted trajectory and a predicted stopping position;

FIG. 5 is a conceptual diagram for explaining a predicted trajectory and a predicted stopping position calculated when a difference between a traveling direction and an imaging direction is not considered;

FIG. 6 is a conceptual diagram showing a predicted trajectory and a predicted stopping position calculated by the display device according to the present embodiment;

FIG. 7 is a block diagram showing a schematic configuration of a display system according to the present embodiment;

FIG. 8 is a flowchart showing a display method realized by the display system according to the present embodiment; and

FIG. 9 is a conceptual diagram showing an example of a stopping positions calculated in the display method shown in FIG. 8.

### EMBODIMENTS

Hereinafter, an embodiment of the present disclosure will be described with reference to the drawings. Note that when the numerals of the numbers, the quantities, the amounts, the ranges and the like of the respective elements are mentioned in the embodiments shown as follows, the present disclosure is not limited to the mentioned numerals unless specially explicitly described otherwise, or unless the present disclosure is explicitly specified by the numerals theoretically. Furthermore, structures or the like that are described in conjunction with the following embodiment is not necessary to the concept of the present disclosure unless explicitly described otherwise, or unless the present disclosure is explicitly specified by the structures or the like theoretically. Note that in the respective drawings, the same or corresponding parts are assigned with the same reference signs, and redundant explanations of the parts are properly simplified or omitted.

### 1. Outline

A display system according to the present embodiment provides a function displaying traveling video of a vehicle on a display device. In particular, the display system according to the present embodiment displays a predicted trajectory and a predicted stopping position of the vehicle to be superimposed on the traveling video. The display of the predicted trajectory and the predicted stopping position of the vehicle is one of AR (Augmented Reality) displays. Hereinafter, the function displaying the predicted trajectory and the predicted stopping position of the vehicle to be superimposed on the traveling video is also referred to as “AR display function”.

Such a display system is considered to be employed in a remote driving system in which a driving operation is determined by visually recognizing traveling video displayed on a display device. In particular, the AR display function is effective in remote driving in which it is difficult to obtain a feeling of driving as compared with a case where the operator actually gets on the vehicle and drives the vehicle. For example, the AR display of the predicted trajectory can improve the operability of the driving operation related to the steering of the vehicle. The AR display of the predicted stopping position can prompt the operator so that the predicted stopping position falls within the lane. Accordingly, for example, in a case where communication related to remote driving is disrupted and processing for stopping (for example, constant deceleration with a fixed steering angle) is performed on the vehicle side, it is possible to suppress lane departure. In addition, the inventors of the present disclosure have confirmed that the vehicle speed tends to decrease by the AR display. As a result, an improvement in safety of the vehicle can be expected.

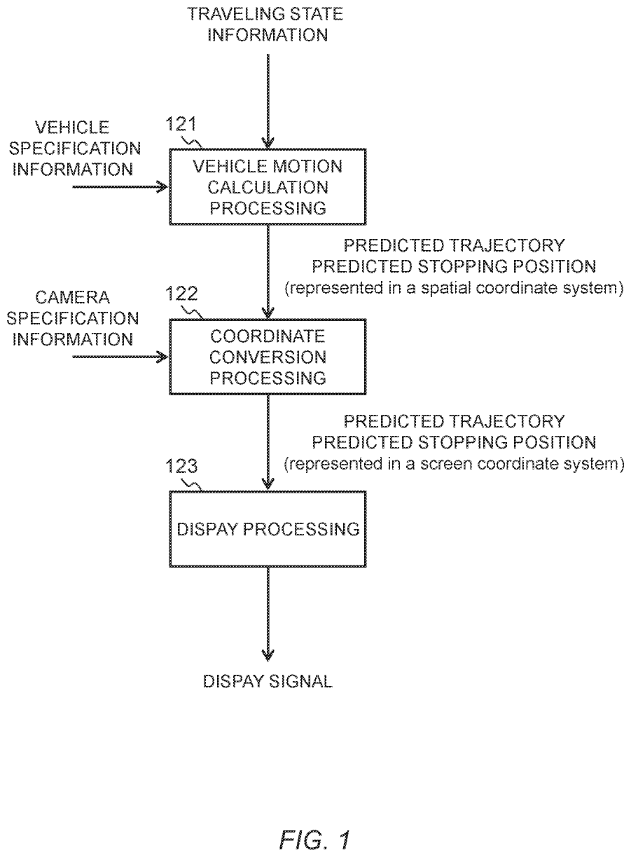

FIG. 1 is a block diagram for explaining the AR display function of the display system according to the present embodiment. The AR display function includes a vehicle motion calculation processing 121, a coordinate conversion processing 122, and a display processing 123.

First, in the vehicle motion calculation processing 121, the predicted trajectory and the predicted stopping position of the vehicle are calculated based on traveling state information and vehicle specification information of the vehicle. Examples of the traveling state information of the vehicle include a vehicle speed, an acceleration/deceleration, and a steering angle. Examples of the vehicle specification information include a vehicle weight, a weight distribution ratio, a stability factor, cornering power, a wheel base, and a steering gear ratio.

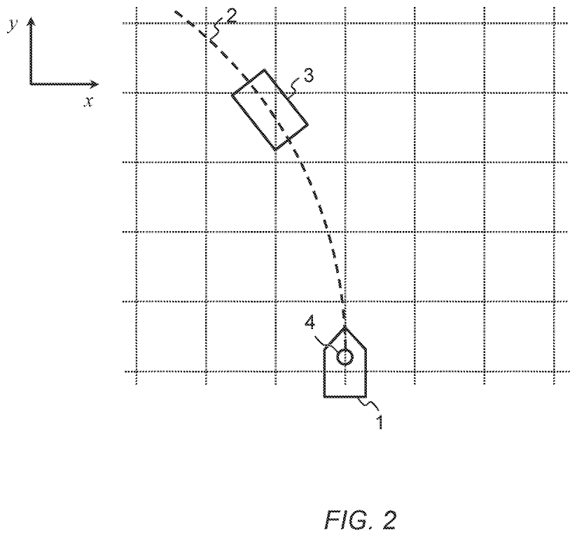

In the vehicle motion calculation processing 121, the predicted trajectory and the predicted stopping position of the vehicle represented in a spatial coordinate system are given as a processing result. FIG. 2 shows an example of the predicted trajectory 2 and the predicted stopping position 3 of the vehicle 1 calculated in the vehicle motion calculation processing 121. In the example shown in FIG. 2, the spatial coordinate system is a two-dimensional orthogonal coordinate system. Therefore, the predicted trajectory 2 and the predicted stopping position 3 are represented by two-dimensional coordinates (x, y). In the example shown in FIG. 2, the predicted trajectory 2 starting from a point 4 (which represents the current position of the vehicle 1) is calculated.

Refer to FIG. 1 again. Next, in the coordinate conversion processing 122, coordinate conversion of the predicted trajectory 2 and the predicted stopping position 3 calculated in the vehicle motion calculation processing 121 is performed based on camera specification information of a camera for capturing the traveling video. Then, in the coordinate conversion processing 122, the predicted trajectory and the predicted stopping position of the vehicle represented in a screen coordinate system are given as a processing result. Examples of the camera specification information include an installation position, an installation angle, and an angle of view of the camera. The screen coordinate system give a position on the image captured by the camera, and the position of the screen coordinate system can be given corresponding to the position of the spatial coordinate system.

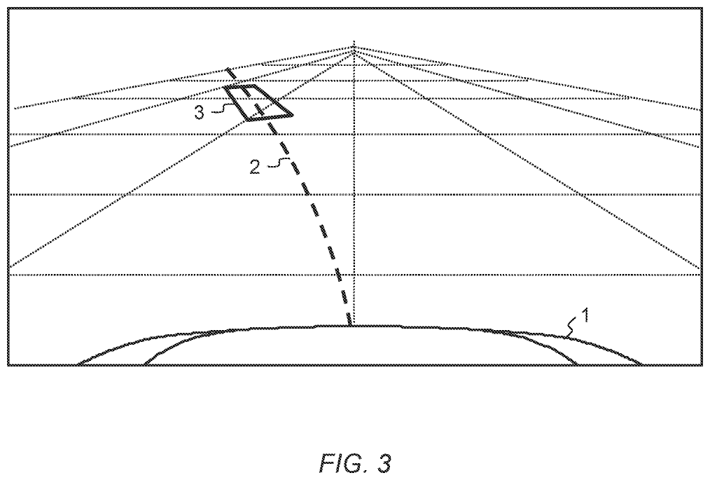

FIG. 3 shows an example of the predicted trajectory 2 and the predicted stopping position 3 calculated in the coordinate conversion processing 122. FIG. 3 shows the predicted trajectory 2 and predicted stopping position 3 represented in the screen coordinate system corresponding to these represented in the spatial coordinate system shown in FIG. 2.

Refer to FIG. 1 again. Next, the display processing 123 generates a display signal for AR-displaying the predicted trajectory 2 and the predicted stopping position 3 calculated in the coordinate conversion processing 122 on the display device. The AR display of the predicted trajectory 2 and the predicted stopping position 3 is realized by the display device performing display according to the display signal generated by the display processing 123.

Further, by displaying the traveling video on the display device, the predicted trajectory 2 and the predicted stopping position 3 can be superimposed on the traveling video.

When the vehicle 1 is kept at a constant vehicle speed and a constant steering angle is given to the vehicle 1, the vehicle 1 will perform steady circular turning with reference to a turning circle corresponding to the vehicle speed and the steering angle. Therefore, when a steering angle is given to the vehicle 1, it is expected that the predicted trajectory 2 is a steady circular turning trajectory determined according to the current vehicle speed and the steering angle of the vehicle 1. And it is expected that the predicted stopping position 3 is given along the steady circular turning trajectory. When no steering angle is given to the vehicle 1, the predicted trajectory 2 may be a straight line extending in front of the vehicle 1.

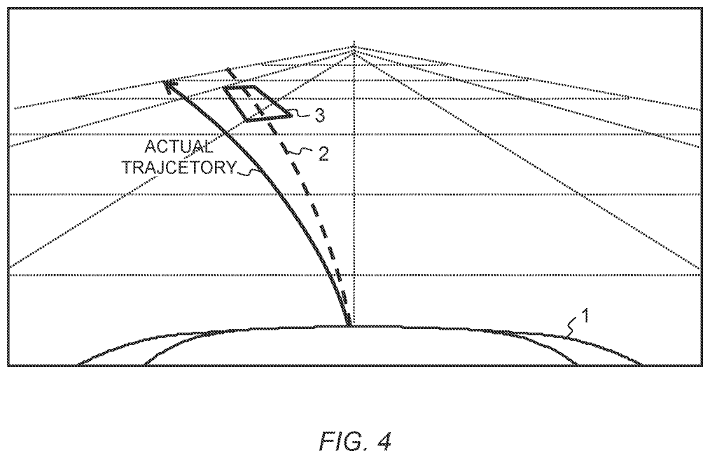

However, the inventors of the present disclosure have confirmed a problem that, when the steady circular turning trajectory starting from the current position of the vehicle 1 is displayed as the predicted trajectory 2, the predicted trajectory 2 and the predicted stopping position 3 are AR-displayed with deflection to the outside or inside of the turning with respect to the actual trajectory of the vehicle 1. FIG. 4 shows a conceptual diagram of this problem. FIG. 4 shows a case where the predicted trajectory 2 and the predicted stopping position 3 are AR-displayed with deflection to the outside of the turning with respect to the actual trajectory of the vehicle 1. As shown in FIG. 4, the deflection increases with increasing distance from the vehicle 1. When the vehicle travels at an extremely low speed such as while the vehicle is parking, such a deflection has a small influence on the driving operation. But the deflection has a large influence on the driving operation when the vehicle travels in a medium to high-speed range. Therefore, AR-displaying the predicted trajectory 2 and the predicted stopping position 3 with high accuracy is required.

With respect to this problem, the inventors of the present disclosure have found that while the camera is fixed to the body of the vehicle 1, the body is inclined with respect to the traveling direction of the vehicle 1 due to a slip angle occurred in the vehicle 1. That is, while the traveling direction of the vehicle 1 is a direction along the steady circular turning trajectory, the imaging direction of the camera is a direction of the body of the vehicle 1. Therefore, if a difference between these directions is not considered, the predicted trajectory 2 and the predicted stopping position 3 are AR-displayed with deflection to the outside or inside of the turning with respect to the actual trajectory of the vehicle 1.

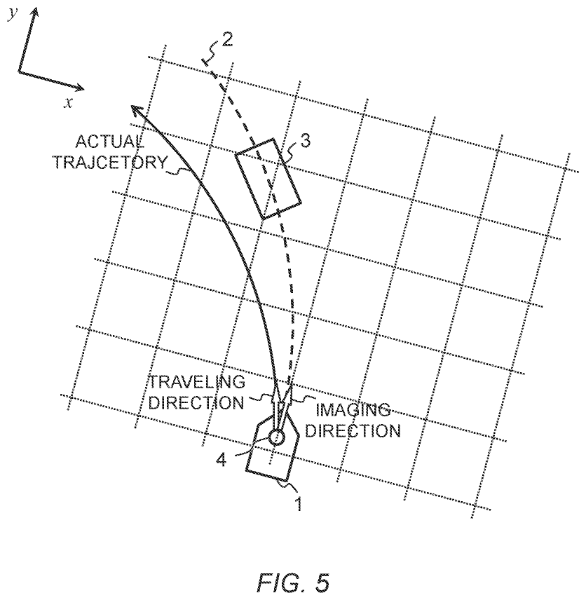

FIG. 5 is a conceptual diagram for explaining the predicted trajectory 2 and the predicted stopping position 3 calculated when the difference between the traveling direction and the imaging direction is not taken into consideration. In this case, considering that the screen coordinate system is given corresponding the position of the spatial coordinate system, the spatial coordinate system in the vehicle motion calculation processing 121 is given with reference to the imaging direction. Therefore, as shown in FIG. 5, the predicted trajectory 2 is deflected to the outside or inside of the turning with respect to the actual trajectory (in FIG. 5, the predicted trajectory 2 is deflected to the outside because of the way of giving the traveling direction).

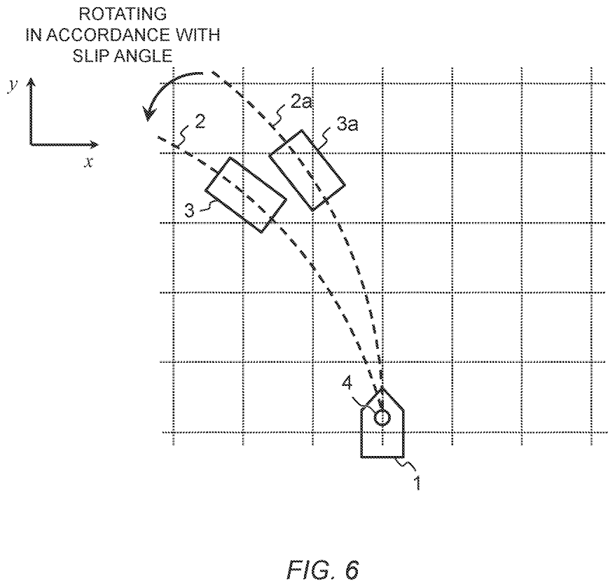

Therefore, in order to cope with this problem, the display system according to the present embodiment estimates the slip angle of the vehicle 1. Then, the display system calculates the predicted trajectory 2 and the predicted stopping position 3 by rotating the steady circular turning trajectory in accordance with the slip angle. FIG. 6 shows the predicted trajectory 2 and the predicted stopping position 3 calculated in the vehicle motion calculation processing 121 in the display system according to the present embodiment. First, a steady circular turning trajectory 2a starting from the point 4 and a stopping position 3a provided at a position along the steady circular turning trajectory 3a are calculated. Thereafter, as shown in FIG. 6, by rotating the steady circular turning trajectory 2a and the stopping position 3a in accordance with the slip angle, the predicted trajectory 2 and the predicted stopping position 3 which are the processing results of the vehicular motion calculation processing unit 121 are calculated. As a result, it is possible to suppress the deviation of the predicted trajectory 2 and the predicted stopping position 3 with respect to the actual trajectory, and it is possible to perform the AR display of the predicted trajectory 2 and the predicted stopping position 3 with high accuracy.

### 2. Display System

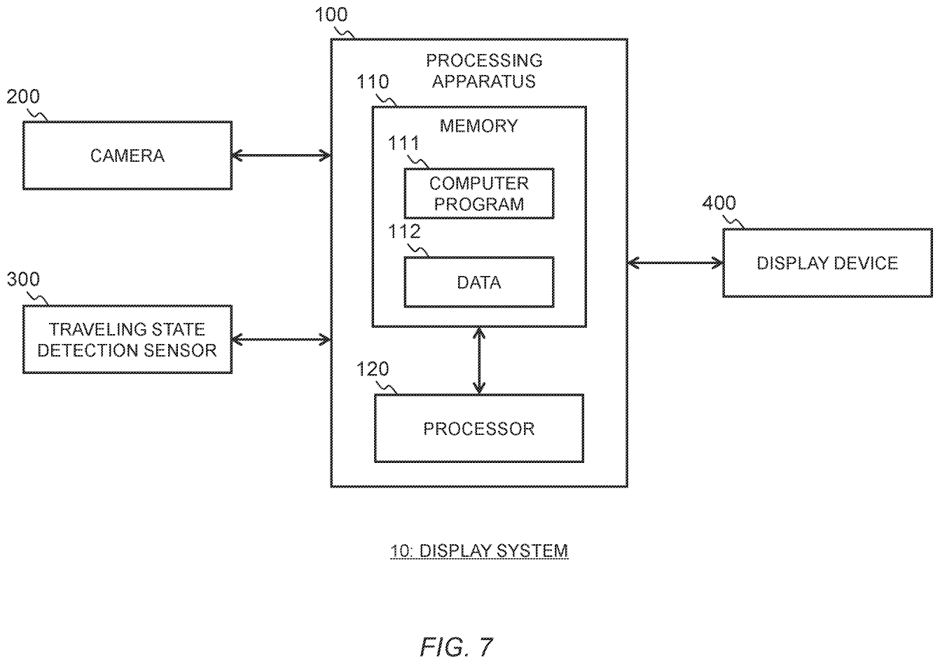

Hereinafter, a configuration of the display system according to the present embodiment will be described. FIG. 7 is a block diagram showing a schematic configuration of the display system 10 according to the present embodiment. The display system 10 includes a processing apparatus 100, a camera 200, a traveling state detection sensor 300, and a display device 400. The processing apparatus 100 is connected to the camera 200, the traveling state detection sensor 300, and the display device 400 so as to transmit information to each other. For example, electrical connection via a cable, connection via an optical communication line, connection by wireless communication via a wireless communication terminal, and the like can be given. Note that the transmission of information may be performed indirectly via a relay device.

The camera 200 is provided in the vehicle 1 and captures the traveling video of the vehicle 1. The traveling video captured by the camera 200 is transmitted to the processing apparatus 100.

The traveling state detection sensor 300 is a sensor that detects and outputs traveling state information of the vehicle 1. Examples of the traveling state detection sensor 300 include a wheel speed sensor that detects a vehicle speed of the vehicle 1, a accelerometer that detects an acceleration/deceleration of the vehicle 1, a steering angle sensor that detects a steering angle of the vehicle 1, and a GPS receiver that acquires GPS data of the vehicle 1. The detected traveling state information is communicated to the processing apparatus 100.

The processing apparatus 100 is a computer that outputs a display signal for controlling the display of the display device 400 based on acquired information. The processing apparatus 100 may be a computer that outputs the display signal as one of its functions. For example, the processing apparatus 100 may be a computer that is provided in a remote driving apparatus and executes processing related to remote driving.

The processing apparatus 100 includes one or more memories 110 and one or more processors 120.

The one or more memories 110 store a computer program 111 executable by the one or more processors 120 and data 112 necessary for processing executed by the one or more processors 120. Examples of the one or more memories 110 include a volatile memory, a non-volatile memory, an HDD, and an SSD. The acquired Information of the processing apparatus 100 is stored in the one or more memories 110 as the data 112.

The computer program 111 includes a program for generating a display signal for displaying the traveling video on the display device 400, and a program for generating a display signal for AR-displaying the predicted trajectory 2 and the predicted stopping position 3 on the display device 400.

Examples of the data 112 include the traveling video acquired from the camera 200, the traveling state information acquired from the traveling state detection sensor 300, and parameter information related to the computer program 111. In the present embodiment, the data 112 includes the vehicle specification information. The vehicle specification information may be given by acquisition by the processing apparatus 100, or may be given in advance as parameter information related to the computer program 111.

The one or more processors 120 read the computer program 111 and the data 112 from the one or more memories 110, and execute processing according to the computer program 111 based on the data 112. Thus, the display signal for displaying the traveling video and the display signal for AR-displaying the predicted trajectory 2 and the predicted stopping position 3 are generated. That is, the vehicle motion calculation processing 121, the coordinate conversion processing 122, and the display processing 123 are realized by the one or more processors 120.

The display device 400 performs display in accordance with the display signal acquired from the processing apparatus 100. The display device 400 is, for example, a monitor provided in a cockpit in a remote driving system. When the display device 400 performs display in accordance with the display signal, the display of the traveling video and the AR display of the predicted trajectory 2 and the predicted stopping position 3 are realized.

### 3. Display Method

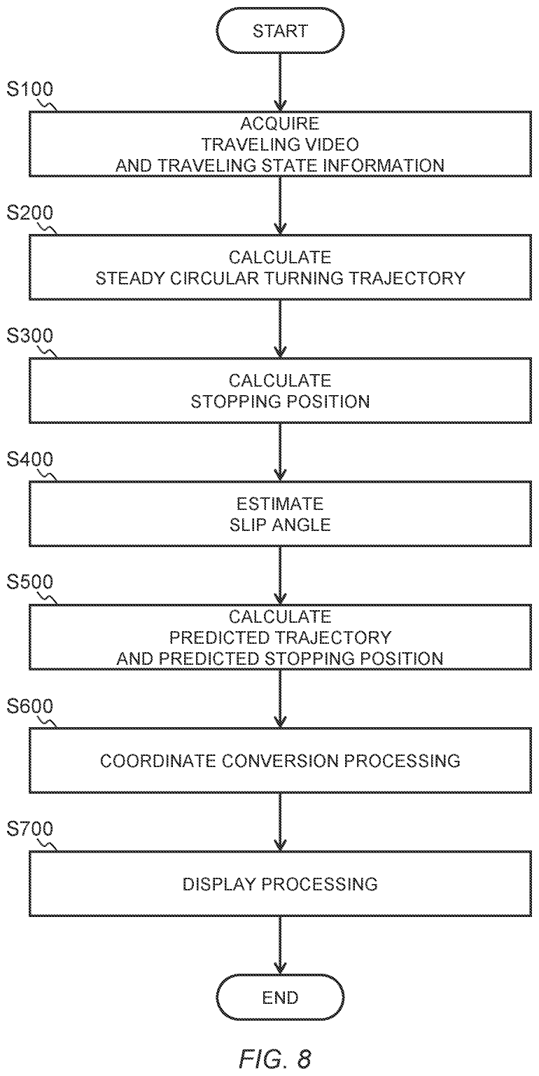

Hereinafter, a display method realized by the display system 10 according to the present embodiment will be described. FIG. 8 is a flowchart showing the display method realized by the display system 10 according to the present embodiment. The flowchart shown in FIG. 8 is repeated at a predetermined cycle, and each processing is executed at each predetermined execution cycle.

In Step S100, the processing apparatus 100 acquires the traveling video captured by the camera 200 and the traveling state information detected by the traveling state detection sensor 300.

In Step S200, the one or more processors 120 calculate a steady circular turning trajectory 2a based on the traveling state information. The steady circular turning trajectory 2a can be calculated from the turning radius of the vehicle 1. The turning radius R can be calculated by the following Formula 1.

$$R = ( 1 + A * {V}^{2} ) * \frac{l}{δ} \qquad [ Formula 1 ]$$

Here, V is the vehicle speed of the vehicle 1, and δ is the steering angle of the vehicle 1, which are acquired as the traveling state information. Further, A is a stability factor of the vehicle 1, and 1 is a wheelbase of the vehicle 1, which are acquired as the vehicle specification information.

The turning radius R may be calculated by another method. For example, the turning radius R can be estimated from GPS data of the vehicle 1.

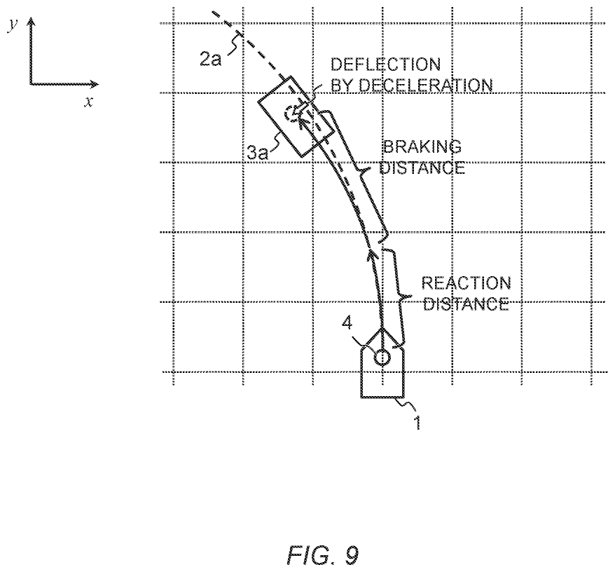

In Step S300, the one or more processors 120 calculate a stopping position 3a based on the traveling state information. Here, the one or more processors 120 can calculate, as the stopping position 3a, a position advanced from the current position of the vehicle 1 by a reaction distance and a braking distance along the steady circular turning trajectory calculated in Step S200. However, regarding the braking distance, a deviation by deceleration may be taken into consideration. FIG. 9 shows an example of the stopping position 3a calculated in Step S300.

Here, the reaction distance is a distance traveled by the vehicle 1 until the braking of the vehicle 1 is started. The reaction distance can be calculated from the vehicle speed of the vehicle 1 and the time until the braking of the vehicle 1 is started. As the time until the braking of the vehicle 1 is started, an appropriate time may be given in advance as the computer program 111 or the data 112. For example, in the remote driving system, it is considered that the time until the braking of the vehicle 1 is started is given by the time until the control for stopping is started after it is determined that the communication is disrupted. As another example, the time until the braking of the vehicle 1 is started may be given as the reaction time of the operator. The braking distance is a distance traveled by the vehicle 1 from the start of braking of the vehicle 1 to the stop of the vehicle 1. The braking distance can be calculated from the vehicle speed of the vehicle 1 and a predetermined deceleration. The vehicle speed of the vehicle 1 and the predetermined deceleration are acquired as the traveling state information. The predetermined deceleration may be given in advance as the computer program 111 or the data 112.

Refer to FIG. 8 again. In Step S400, the one or more processors 120 estimate the slip angle based on the traveling state information. For example, a steady slip angle β shown in the following Formula 2 can be estimated as the slip angle of the vehicle 1.

$$β = {G}_{β} * δ {G}_{β} = \frac{{d}_{f} ( 1 - \frac{{V}^{2}}{g * l * {d}_{f} * {C}_{r}} )}{1 + A * {V}^{2}} \qquad [ Formula 2 ]$$

Here, df is the weight distribution ratio of the vehicle 1, and Cr is the cornering power of the rear wheels of the vehicle 1, which are acquired as the vehicle specification information. G is a gravitational acceleration, and is given in advance as the computer program 111 or the data 112.

The slip angle may be estimated by other methods. For example, a slip angle sensor may be provided in the vehicle 1, and the slip angle of the vehicle 1 may be detected by the slip angle meter.

In Step S500, the one or more processors 120 rotate the steady circular turning trajectory 2a calculated in Step S200 and the stopping position 3a calculated in Step S300 in accordance with the slip angle calculated in Step S400 to calculate the predicted trajectory 2 and the predicted stopping position 3.

In Step S600, the one or more processors 120 perform coordinate conversion of the predicted trajectory 2 and the predicted stopping position 3 calculated in Step S500 to calculate these represented in the screen coordinate system.

In Step S700, the one or more processors 120 generate the display signal for displaying the traveling video and the display signal for AR-displaying the predicted trajectory 2 and the predicted stopping position 3 calculated in Step S600. Then, the display device performs display according to the display signal generated in Step S700.

### 4. Effects

As described above, according to the present embodiment, the steady circular turning trajectory 2a and the stopping position 3a are calculated, and the slip angle is estimated. And the predicted trajectory 2 and the predicted stopping position 3 are calculated by rotating the steady circular turning trajectory 2a and the stopping position 3a in accordance with the slip angle. Then, the predicted trajectory 2 and the predicted stopping position 3 are AR-displayed. Accordingly, it is possible to suppress the deviation of the predicted trajectory 2 and the predicted stopping position 3 with respect to the actual trajectory, and it is possible to perform the AR display of the predicted trajectory 2 and the predicted stopping position 3 with high accuracy.

The display system 10 according to the present embodiment may be configured to perform AR display of only one of the predicted trajectory 2 and the predicted stopping position 3. Further, it is also possible to adopt only the AR display function according to the display system 10 by applying it to a head-up display or the like.

What is claimed is:

1. A system comprising:
a camera for capturing traveling video of a vehicle;
a sensor for detecting traveling state information of the vehicle;
a display device; and
one or more processors configured to execute:
calculating a steady circular turning trajectory of the vehicle based on the traveling state information;
estimating a slip angle of the vehicle based on the traveling state information;
rotating the steady circular turning trajectory in accordance with the slip angle to calculate a predicted trajectory; and
displaying the traveling video and the predicted trajectory on the display device in a superimposed manner.

2. The system according to claim 1, wherein
the one or more processors are further configured to execute:
calculating a stopping position of the vehicle based on the traveling state information;
rotating the stopping position in accordance with the slip angle to calculate a predicted stopping position; and
displaying the predicted stopping position to be superimposed on the traveling video on the display device.

3. The system according to claim 2, wherein
the calculating the stopping position includes:
calculating a reaction distance determined by a vehicle speed of the vehicle;
calculating a braking distance determined by the vehicle speed and a predetermined deceleration; and
calculating, as the stopping position, a position advanced from a current position of the vehicle along the steady circular turning trajectory by the reaction distance and the braking distance.

4. A method displaying traveling video of a vehicle captured by a camera on a display device, the method comprising:
calculating a steady circular turning trajectory of the vehicle based on traveling state information of the vehicle;
estimating a slip angle of the vehicle based on the traveling state information;
rotating the steady circular turning trajectory in accordance with the slip angle to calculate a predicted trajectory; and
displaying the traveling video and the predicted trajectory on the display device in a superimposed manner.

5. The method according to claim 4, further comprising:
calculating a stopping position of the vehicle based on the traveling state information;
rotating the stopping position in accordance with the slip angle to calculate a predicted stopping position; and
displaying the predicted stopping position to be superimposed on the traveling video on the display device.
